(19) United States
(12) Patent Application Publication
(10) Pub. No.: US 2013/0141101 A1
(43) Pub. Date: Jun. 6, 2013

(54) RADIO FREQUENCY ASSISTED GEOSTRUCTURE ANALYZER

(71) Applicant: Anatolii Kudelia, Kyiv (UA)

(72) Inventor: Anatolii Kudelia, Kyiv (UA)

(21) Appl. No.: 13/817,438

(22) PCT Filed: Dec. 13, 2010
(86) PCT No.: PCT/UA2010/000093

§ 371 Date: Feb. 15, 2013

(30) Foreign Application Priority Data
Aug. 18, 2010 (UA) A 2010 10195
Oct. 27, 2010 (UA) A 2010 12752

(51) Int. Cl. G01V 3/12

(52) U.S. Cl. CPC G01V 3/12
USPC 324/337

(57) ABSTRACT

The invention relates to instruments designated for geophysical survey, in particular for soil mass exploration using electromagnetic waves. Radio frequency assisted geostructure analyzer comprising transmitting antenna and radio transmitter (2) installed on the first pillar (3), with transmitting antenna consisting of transmitting loop (1) and antenna rod (10), and also receiving loop (4) and radio receiver (7) installed on the second pillar (9), and receiving ferrite antenna (5).

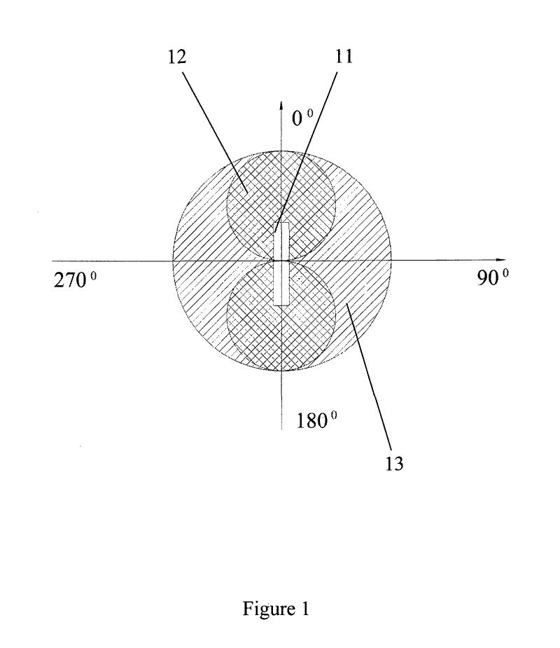

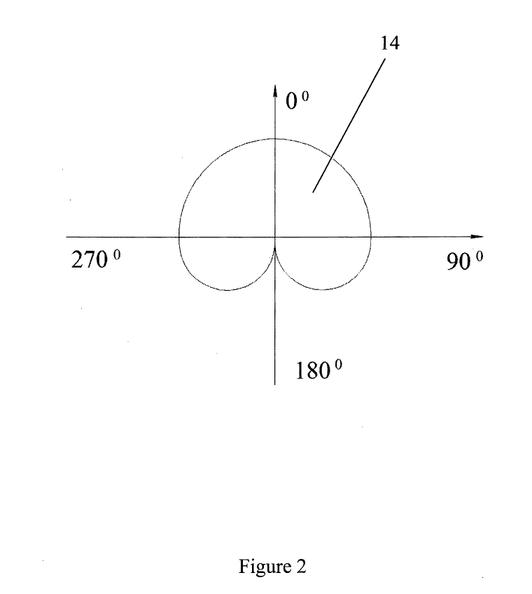

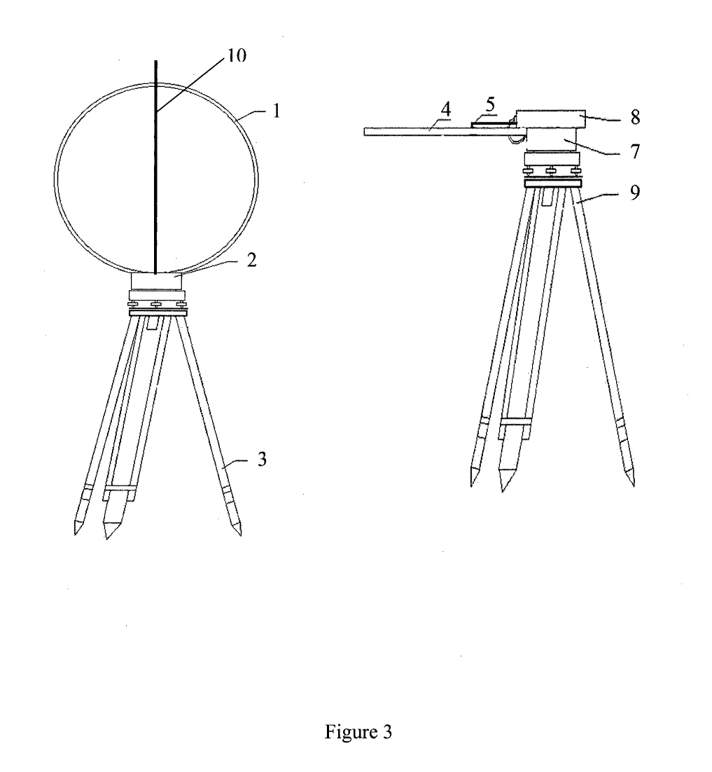

### TECHNICAL FIELD

The invention relates to instruments designated for geophysical survey, in particular for soil mass exploration using electromagnetic waves.

### BACKGROUND ART

Geophysical survey of soil masses is conducted during geological exploration to determine the soil mass structure and draw conclusion on whether a soil mass section is suitable for construction of structures and buildings, as well as to identify troublesome zones in soil masses, for example, glide lines, natural and man-made cavities, soil mass horizons watered by underground waters, etc.

One of the methods of geophysical survey of soil masses is exploration of the soil mass structure using electromagnetic waves. Instruments used for exploration of the site structure using electromagnetic waves are called radio frequency assisted geostructure analyzer. The very method of exploration of the soil mass structure using electromagnetic waves was developed yet in the 60s of the twentieth century. Application of radio frequency assisted geostructure analyzer for geophysical survey of soil masses began to gain popularity about twenty years ago. The principle of operation of radio frequency assisted geostructure analyzer lies in generation of primary electromagnetic field at certain point of soil mass section surface passing through soil mass and generating secondary electromagnetic field, with secondary electromagnetic field parameters subsequently being fixed at certain points of soil mass section surface.

Radio frequency assisted geostructure analyzer may vary in their performance, but most of them have the following basic elements: transmitting antenna, radio transmitter, receiving antenna and radio receiver. Thus, there is a well-known radio frequency assisted geostructure analyzer (patent Russian Federation RU2328021 C2, printed on 27 Jun. 2008) comprising transmitting antenna and radio transmitter installed on the first pillar, and also receiving loop, spatially arranged antenna, radio receiver and unit measuring signal fed from spatially arranged antenna installed on the second pillar. Transmitting antenna and radio transmitter generate primary electromagnetic field. As transmitting antenna the transmitting loop is used—application of loops in radio frequency assisted geostructure analyzer as transmitting and receiving antennas is a classic performance of radio frequency assisted geostructure analyzer. Transmitting antenna and receiving loop should be arranged in perpendicular conventional planes, with transmitting antenna frame being often located in vertical conventional plane and receiving loop frame in horizontal conventional plane. This is explained by the fact that electromagnetic field has so called magnetic and electric components, and the way electromagnetic waves pass through soil masses stipulates that the most informative component of secondary electromagnetic field is vertical magnetic component of secondary electromagnetic field (denoted as H_{z}), and the above-mentioned spatial arrangement of transmitting antenna and receiving loop allows to measure precisely the amplitude of vertical magnetic component of secondary electromagnetic field.

Geophysical survey is conducted as follows: one chooses several points on soil mass section surface at which transmitting antenna with radio transmitter and receiving loop with radio receiver are to be located, measures strength of receiving loop signal, and then based on measurement results draws cross-plots of receiving loop signal versus measurement point coordinates and makes interpretation of cross-plots obtained. Interpretation of obtained cross-plots means visual detection of maximum, minimum and inflexion points thereon at which changes in the soil mass structure are observed.

The drawback of this well-known instrument is low accuracy of measurements in certain complex environment of geophysical survey, e.g. in a city with many sources of artificial electromagnetic fields, as well as possible presence of so-called “parasitic component” in secondary electromagnetic field perceived by receiving loop containing no useful information about soil mass between location points of transmitting antenna and receiving loop.

Presence of parasitic component in secondary electromagnetic field is caused by that horizontal directional pattern of transmitting loop appears as figure “8”, i.e. electromagnetic field of transmitting loop consists of two symmetrically located parts which are called arms on directional pattern. Therefore, transmitting loop is bidirectional antenna. When conducting geophysical survey of soil masses using radio frequency assisted geostructure analyzer the compulsory condition shall be certain mutual arrangement of transmitting loop and receiving loop, with transmitting loop frame being arranged so that conventional vertical plane in which transmitting loop frame is located crosses the symmetry center of receiving loop frame. With such mutual arrangement of transmitting and receiving loops, the vector of maximum voltage of one of electromagnetic field arms of transmitting loop according to transmitting loop pattern will be directed precisely towards the symmetry center of receiving loop—this electromagnetic field arm of transmitting loop is called near-field arm of transmitting loop (as it is closer to receiving loop). Accordingly, another electromagnetic field arm of transmitting loop will be called far-field arm of transmitting loop.

When electromagnetic field of transmitting loop (near-field arm and far-field arm of transmitting loop) is passing through soil mass there will be generated secondary electromagnetic field between location points of transmitting and receiving loop.

When conducting geophysical survey in a city, transmitting loop may be located near to a building or structure so that the building or structure may get, according to transmitting loop pattern, into the far-field arm zone of transmitting loop. If this is the case, the building or structure will also contribute to generation of secondary electromagnetic field, i.e. secondary electromagnetic field will have both component formed by soil mass, and parasitic component formed by the building or structure. In this event, interpretation of obtained cross-plots of receiving loop signal versus measurement point coordinates may be in error about changes in the soil mass structure or lead to wrong conclusions.

In addition, measurement of receiving loop signal provides data only on changes in the soil mass structure in space, however allows no to determine what exactly caused changes in the soil mass structure: changes in receiving loop signal may be caused both by soil mass cavities, and as the result of changes in watered soil mass horizons, i.e. obtained data provide no complete information about the soil mass structure and layers. To receive data on the soil mass structure one has to perform additional well drilling for soil sampling from soil masses and compare the results of soil samples with cross-plots obtained.

### SUMMARY OF INVENTION

Object of the invention is to modernize radio frequency assisted geostructure analyzer by integrating new elements.

This object is met by radio frequency assisted geostructure analyzer comprising transmitting antenna and radio transmitter installed on the first pillar, with transmitting antenna consisting of transmitting loop and antenna rod, and also receiving loop and radio receiver installed on the second pillar, and receiving ferrite antenna.

In addition, radio transmitter may be designed so that signals fed to transmitting loop and antenna rod are matched so that horizontal directional pattern of transmitting antenna gets a cardioid shape.

In addition, radio frequency assisted geostructure analyzer may comprise at least one element installed on the first pillar and designated to match signals fed from radio transmitter to transmitting loop and transmitting antenna rod so that horizontal directional pattern of transmitting antenna gets a cardioid shape.

In addition, radio receiver may be designed so that it has channel to measure signal fed from receiving loop and channel to measure signal fed from receiving ferrite antenna.

In addition, radio frequency assisted geostructure analyzer may be equipped with additional second radio receiver designated to measure signal fed from receiving ferrite antenna.

In addition, radio frequency assisted geostructure analyzer may be additionally equipped with unit measuring phase difference between signal fed from receiving loop and that fed from ferrite antenna.

In addition, receiving ferrite antenna may be arranged towards receiving loop so that its frame and that of receiving loop are located in parallel or coinciding conventional planes.

In addition, receiving ferrite antenna may be installed on the second pillar.

In addition, radio frequency assisted geostructure analyzer may be equipped with additional third pillar, with receiving ferrite antenna being installed thereon.

In addition, at least one of three pillars may be movable or mobile.

Technical result of the invention: designing of transmitting antenna as a system of two antennas (transmitting loop and antenna rod) results in creation of unidirectional transmitting antenna with horizontal directional pattern in a cardioid shape, which in its turn if geophysical survey is conducted in a city minimizes the impact of ground and underground facilities on measurement results and increases measurement accuracy; the presence of two receiving antennas (receiving loop and receiving ferrite antenna), the presence of receiver having channel to measure signal fed from receiving loop and channel to measure signal fed from receiving ferrite antenna, or the presence of two radio receivers allows to measure two signals and increase the accuracy of measurement of secondary electromagnetic field parameters; mutual arrangement of receiving loop and receiving ferrite antenna when receiving ferrite antenna is arranged towards receiving loop so that receiving ferrite antenna frame and receiving loop frame are located in parallel or coinciding conventional planes is the most optimal in most cases of geophysical survey, since this allows to measure the value of such component of primary electromagnetic field as its horizontal magnetic component (denoted as H_{y}) and the value of such component of primary electromagnetic field as its horizontal electric component (denoted as E_{θ}); availability of unit measuring phase difference between signal fed from receiving loop and that fed from ferrite antenna allows to get additional data for determination of soil mass components and reduce the volume of additional geological survey works or minimize them if there are the results of prior geological surveys.

Correlation of new essential features of the invention with claimed technical result is explained below in drawings.

### BRIEF DESCRIPTION OF DRAWINGS

View 1—transmitting loop pattern and antenna rod pattern.

View 2—transmitting antenna pattern of radio frequency assisted geostructure analyzer.

View 3—general view of radio frequency assisted geostructure analyzer.

### DESCRIPTION OF EMBODIMENTS

New essential features of the invention are correlated with claimed technical result as follows.

Transmitting antenna of Description of Embodiments is designed so that it comprises two antennas—transmitting loop and antenna rod.

Antenna rod is an antenna in the form of a rod arranged in vertical (or off-vertical) position and made of metal (e.g. solid metallic rod or metal tubes). Such an antenna is often mentioned in the literature as vertical antenna.

Transmitting loop (11) (shown on View 1 as top view) has horizontal directional pattern (12) (shown on View 1) in the form of figure “8”, i.e. this antenna is bidirectional. Antenna rod located near to transmitting loop (not shown on View 1) has horizontal directional pattern (13) (shown on View 1) in the form of a circle, i.e. this antenna is omnidirectional.

If the above two antennas (transmitting loop and antenna rod) are arranged together, their emitted electromagnetic fields will generate composite electromagnetic field characterized by composite directional pattern, i.e. the system of two antennas, namely transmitting loop and antenna rod, operates as one transmitting antenna. Directional pattern of such transmitting antenna is composite directional pattern of transmitting loop and antenna rod. If signals fed to transmitting loop and antenna rod are somehow matched by phase (signal fed to transmitting loop is lagging in phase by certain angle from that fed to antenna rod), horizontal directional pattern of transmitting antenna will get a cardioid shape, as shown on View 2 (14). Transmitting antenna with horizontal directional pattern in the form of cardioid is unidirectional, i.e. transmitting antenna radiation is directed in one direction.

When conducting geophysical survey of soil masses using this invention, the compulsory condition shall be specified mutual arrangement of transmitting antenna and receiving loop of radio frequency assisted geostructure analyzer, with transmitting loop frame being arranged so that the vector of maximum voltage of transmitting antenna electromagnetic field (which value corresponds to maximum voltage of electromagnetic fields on cardioid pattern) is directed precisely towards the symmetry center of receiving loop. Zone on soil mass surface located at certain distance from transmitting antenna on the side opposite to the direction towards receiving loop may be conventionally called “blind area of transmitting antenna”. Any facilities located in the blind area of transmitting antenna will be outside the area of electromagnetic field of transmitting antenna, and therefore will not affect electromagnetic field of transmitting antenna.

If when conducting geophysical survey transmitting antenna of radio frequency assisted geostructure analyzer is located near to any building or structure so that the building or structure falls within the blind area of transmission antenna, such building or structure will not affect electromagnetic field of transmitting antenna and therefore will not contribute to generation of secondary electromagnetic field. In this case, secondary electromagnetic field will have only one component formed by soil mass which improves measurement accuracy when conducting geophysical survey in a city or in other complex environment.

In order directional pattern of transmitting antenna gets a right cardioid shape, signals fed to transmitting and receiving loops should be matched by phase, and signal fed to transmitting loop should lag in phase at about 90° from that fed to antenna rod. Radio frequency assisted geostructure analyzer may be designed so that transmitting loop and antenna rod are connected directly to radio transmitter, with radio transmitter comprising elements designated to match signals fed from radio transmitter to transmitting loop and antenna rod so that signal fed to transmitting loop is lagging in phase at 90° from that fed to antenna rod. Such elements in radio engineering which somehow regulate parameters of multiple signals fed to two or more antennas are called matching units. As an element of radio transmitter one may use matching unit (or units) of any well-known general-circuit solution in the form of separate element (e.g. block, microchip, etc.) or in the form of circuit. Matching unit may also be designed in the form allowing to adjust angle by which signal fed to transmitting loop is lagging from that fed to antenna rod.

Another option of radio frequency assisted geostructure analyzer may comprise an element (or elements) installed on the first pillar and designated to match signals fed from radio transmitter to transmitting loop and antenna rod so that signal fed to transmitting loop is lagging in phase by certain angle from that fed to antenna rod. In this option of radio frequency assisted geostructure analyzer transmitting loop and transmitting antenna rod should be connected to radio transmitter through signal matching element or elements (through matching unit or units). As matching unit (or units) radio frequency assisted geostructure analyzer may use device (or devices) of any well-known general-circuit solution in the form of separate element (e.g. block, microchip, etc.) or in the form of circuit. Matching unit may also be designed in the form allowing to adjust angle by which signal fed to transmitting loop is lagging from that fed to antenna rod.

Measurement of parameters of secondary electromagnetic field in radio frequency assisted geostructure analyzer should be conducted using receiving loop and receiving ferrite antenna. Receiving loop has magnetic dipole properties. Receiving ferrite antenna has both magnetic dipole, and electric dipole properties. Therefore, receiving ferrite antenna located in horizontal plane allows to measure the amplitude of such components of primary electromagnetic field as its horizontal magnetic component (H_{y}) and horizontal electric component (E_{θ}). When conducting geophysical survey one should measure two signals from two receiving antennas and draw two cross-plots of receiving loop and receiving ferrite antenna signals versus measurement point coordinates. Interpretation of such two cross-plots allows to specify points of changes in the soil mass structure, in particular when conducting geophysical survey in cities and other complex geological environment.

Changes in phase difference between signal fed from receiving loop and that fed from receiving ferrite antenna will be different depending on which soil mass component caused changes in the soil mass structure. In case of cavities and watered waters horizons in soil mass, changes in phase difference between signal fed from receiving loop and that fed from receiving ferrite antenna will be absolutely different by nature. Therefore, measurement of phase difference between signal fed from receiving loop and that fed from ferrite antenna allows to draw the third cross-plot which interpretation in conjunction with diagrams of signals fed from receiving loop and receiving ferrite antenna enables to draw conclusions on possible components of the soil mass structure.

View 3 shows as an example one of possible options of radio frequency assisted geostructure analyzer. This option of radio frequency assisted geostructure analyzer comprises first movable pillar designed in the form of a tripod (3), and second movable pillar designed in the form of a tripod (9). On the tripod (3) there is transmitting loop (1) arranged so that its frame is in vertical conventional plane, and also antenna rod (10) and radio transmitter (2). Transmitting loop and antenna rod are both connected to radio transmitter. Radio transmitter comprises matching units which match signals fed to transmitting loop and antenna rod by phase so that horizontal directional pattern of transmitting antenna gets a right cardioid shape. Another option of radio frequency assisted geostructure analyzer may comprise matching units installed on the first pillar near to radio transmitter which radio transmitter signal is fed to, with transmitting loop and antenna rod being connected to matching units.

On the tripod (9) there is receiving loop (4) arranged so that its frame is in horizontal conventional plane, and also receiving ferrite antenna (5), radio receiver (7), unit measuring phase difference between signal fed from receiving loop and that fed from ferrite antenna (8).

Receiving ferrite antenna (5) is designed in the form of a ferrite rod with contour coil made of copper wire loops (not shown). Receiving ferrite antenna (5) is located above receiving loop (4) and arranged so that receiving ferrite antenna frame is in horizontal conventional plane. Such mutual arrangement of receiving ferrite antenna and receiving loop (when both antennas are arranged horizontally) is the most optimal solution for simultaneous measurement of such components of secondary electromagnetic field as vertical magnetic component, horizontal magnetic component and horizontal electric component with vertical polarization in case of geophysical survey of horizontal soil mass section. It is clear that receiving ferrite antenna may be arranged both above or below receiving loop, and in the same conventional plane.

Depending on surface topography of soil mass section there may be other alternative arrangements of receiving ferrite antenna towards receiving loop—for example, in case of sloping soil mass surface one should arrange receiving ferrite antenna inclining to horizontal plane.

In addition, there may be one more alternative arrangement of receiving ferrite antenna on the pillar when receiving loop is installed on the second pillar and receiving ferrite antenna is installed on the third pillar. This alternative is appropriate when to speed up geophysical survey measurements of signal fed from receiving loop and that fed from receiving ferrite antenna are conducted separately—first, one should measure signal fed from receiving loop at certain points on soil mass section surface, determine points at which signal fed from receiving loop is low or high, and then measure signal fed from receiving ferrite antenna only at these points.

In this option of radio frequency assisted geostructure analyzer, radio receiver is designed so that it comprises two channels of measurements—one to measure signal fed from receiving loop and another to measure signal fed from receiving ferrite antenna. Channel means any general-circuit solution in the form of separate element (e.g., block, microchip, etc.) or electric circuit, which allows to measure signals.

In the above option, when receiving loop and receiving ferrite antenna are installed on the second and the third pillar respectively, radio frequency assisted geostructure analyzer may comprise two radio receivers—one to measure signal fed from receiving loop, and another to measure signal fed from receiving ferrite antenna.

As radio receiver one may use any well-known solution allowing to measure signal fed from receiving antenna.

As unit measuring phase difference between signal fed from receiving loop and that fed from ferrite antenna one may use any well-known solution allowing to measure phase difference between signal fed from receiving loop and that fed from ferrite antenna which may be connected either directly to receiving loop and receiving ferrite antenna, or to radio receiver or receivers.

Specialists understand that there may also be an option of radio-wave structuroscope for geophysical survey comprising no unit measuring phase difference between signal fed from receiving loop and that fed from ferrite antenna.

As the first pillar, the second pillar and the third pillar one may use any movable or mobile pillar. Such feature is required to move radio frequency assisted geostructure analyzer along the surface of soil mass section. As movable pillar one may use, for example, tripod. As mobile pillar one may use, for example, truck, car, trailer.

The above examples and options of the invention are only for illustration of the invention, and in no case for restriction thereof.

1. Radio frequency assisted geostructure analyzer comprising transmitting antenna and radio transmitter installed on the first pillar, and also receiving loop and radio receiver installed on the second pillar, characterized in that it is additionally equipped with receiving ferrite antenna, with transmitting antenna consisting of transmitting loop and antenna rod.

2. Radio frequency assisted geostructure analyzer according to claim 1, characterized in that radio transmitter is designed so that signals fed to transmitting loop and antenna rod are matched so that horizontal directional pattern of transmitting antenna gets a cardioid shape.

3. Radio frequency assisted geostructure analyzer according to claim 1, characterized in that it is additionally equipped with at least one element installed on the first pillar and designated to match signals fed from radio transmitter to transmitting loop and antenna rod so that horizontal directional pattern of transmitting antenna gets a cardioid shape.

4. Radio frequency assisted geostructure analyzer according to any claims 1-3, characterized in that radio receiver has channel to measure signal fed from receiving loop and channel to measure signal fed from receiving ferrite antenna.

5. Radio frequency assisted geostructure analyzer according to any claims 1-3, characterized in that it is equipped with additional second radio receiver designated to measure signal fed from receiving ferrite antenna.

6. Radio frequency assisted geostructure analyzer according to any claims 1-5, characterized in that it is additionally equipped with unit measuring phase difference between signal fed from receiving loop and that fed from receiving ferrite antenna.

7. Radio frequency assisted geostructure analyzer according to any claims 1-6, characterized in that receiving ferrite antenna is arranged towards receiving loop so that its frame and that of receiving loop are located in parallel or coinciding conventional planes.

8. Radio frequency assisted geostructure analyzer according to any claims 1-7, characterized in that receiving ferrite antenna is installed on the second pillar.

9. Radio frequency assisted geostructure analyzer according to any claims 1-7, characterized in that it is equipped with additional third pillar which receiving ferrite antenna is located on.

10. Radio frequency assisted geostructure analyzer according to any claims 1-9, characterized in that at least one of three pillars is movable or mobile.
